(19) United States
(12) Patent Application Publication
(10) Pub. No.: US 2015/0282159 A1
(43) Pub. Date: Oct. 1, 2015

(54) METHOD AND SYSTEM FOR PROVIDING SMALL CELL DEPLOYMENT AND ACCESS IN A WIRELESS COMMUNICATION SYSTEM

(71) Applicant: Samsung Electronics Co ., Ltd., Gyeonggi-do (KR)

(72) Inventors: Tushar VRIND, Gyeonggi-do (KR); Diwakar Sharma, Bangalore (IN)

(73) Assignee: Samsung Electronics Co ., Ltd.

(21) Appl. No.: 14/676,251

(22) Filed: Apr. 1, 2015

Related U.S. Application Data
(60) Provisional application No. 61/973,535, filed on Apr. 1, 2014.

(30) Foreign Application Priority Data
Feb. 11, 2015 (KR) 10-2015-0020898

(51) Int. Cl. H04W 72/04; H04W 76/02

(52) U.S. Cl. CPC H04W 72/0413; H04W 72/042; H04W 76/02

(57) ABSTRACT

A method and system for providing small cell deployment and access in a green 3GPP LTE system are disclosed. The method includes establishing, by a UE, an RRC connection with a macro cell, receiving, by the macro cell, an RRC connection establishment message from the UE, wherein the RRC connection establishment message includes an IE including an identity of a list of small cells on which the UE can initiate a connection, determining by the macro cell, at least one small cell for data transfer, verifying, by the macro, if the at least one small cell is in a sleep mode or not, triggering, by the macro cell, a connection setup message for initiating a connection between the UE and the at least one small cell if the small cell is in a wake up mode, sending, by the UE, an SRS for initial timing alignment and allocating by the at least one small cell, an uplink/downlink resource to the UE for communication with the at least one small cell.

### PRIORITY

This application claims priority under 35 U.S.C. §119(e) to a U.S. Provisional Patent Application filed on Apr. 1, 2014 with the United States Patent and Trademark Office and assigned Ser. No. 61/973,535, and a Korean Patent Application, filed on Feb. 11, 2015 in the Korean Intellectual Property Office and assigned Serial No. 10-2015-0020898, the entire contents of which are incorporated herein by reference.

### BACKGROUND

1. Field of the Disclosure

The present disclosure relates generally to wireless communication, and more particularly, to a system and method for enabling small cell deployment and access in a low power (i.e., “green”) 3^{rd} Generation Partnership Project (3GPP) Long Term Evolution (LTE) System.

2. Description of the Related Art

Wireless communication systems are widely deployed to provide various types of communication contents such as, for example, voice, data, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and the like. Additionally, the systems can conform to specifications such as 3^{rd} Generation Partnership Project (3GPP), 3GPP Long Term Evolution (LTE), Ultra-Mobile Broadband (UMB), Evolution Data Optimized (EV-DO), etc.

Generally, wireless multiple-access communication systems simultaneously support communication for multiple mobile devices or User Equipments (UE). Each mobile device may communicate with one or more base stations via transmissions on a forward link and a reverse link. The forward link (or downlink) refers to a communication link from a base station to a mobile device, and the reverse link (or uplink) refers to a communication link from a mobile device to a base station. Further, communication between a mobile device and a base station may be established via Single-Input Single-Output (SISO) systems, Multiple-Input Single-Output (MISO) systems, Multiple-Input Multiple-Output (MIMO) systems, and so forth. In addition, mobile devices can communicate with other mobile devices (and/or base stations with other base stations) in peer-to-peer wireless network configurations.

To supplement conventional base stations, additional low power base stations can be deployed to provide more robust wireless coverage to mobile devices. For example, low power base stations (e.g., which can be commonly referred to as Home Node Bs or Home evolved Node Bs (eNBs), collectively referred to as H(e)NBs, femto nodes, femtocell nodes, pico nodes, micro nodes, etc.) can be deployed for incremental capacity growth, richer user experience, in-building or other specific geographic coverage, and/or the like. Due to their low power, these base stations create small area cells (also referred to herein as “small cells”). In some configurations, such low power base stations are connected to the Internet via a broadband connection (e.g., Digital Subscriber Line (DSL) router, cable or other modem, etc.), which can provide the backhaul link to the mobile operator's network. In this regard, low power base stations are often deployed in homes, offices, etc. without consideration of a current network environment.

The high geometry (high dB) experienced by UEs in some small cell deployments provides the possibility for introducing a higher order modulation scheme (i.e. 256 Quadrature Amplitude Modulation (QAM)) for the downlink transmission. The channel characteristics of a small cell include a low frequency-selective fading channel with a small delay spread and a low time-selective fading, when the UE mobility is low.

FIGS. 1A-1D are schematic network diagrams illustrating different scenarios that are observed by a UE during connection establishment with a macro cell and small cells, according to related art.

FIG. 1A is a schematic network architecture 100 illustrating a scenario of users of both a macro cell and a plurality of small cells of the same frequency while outdoors, according to the related art. The macro cell 102 and the small cells 104a, 104b and 104c use the same frequency, f1, and are outdoors. The macro cell 102 and the cluster of small cells 104a, 104b, and 104c can have a backhaul link created between them and the small cells 104a, 104b, and 104c can have a backhaul link created within the cluster of small cells 104a, 104b, and 104c. As both the macro cell 102 and the small cells 104a, 104b and 104c use the same frequency, interference of the signals occurs. During transmission, the macro cell 102 and the small cells 104a, 104b and 104c can pose a problem for each another, thereby hampering performance and efficiency of each cell.

FIG. 1B is a schematic network architecture 110 illustrating a scenario of both a macro cell 112 and a plurality of small cells 114a, 114b, and 114c of different frequencies while outdoors, according to the related art. The macro cell 112 and the cluster of small cells 114a, 114b and 114c have different frequencies, f1 and f2, and are outdoors. The macro cell 112 and the small cells 114a, 114b, and 114c can have a backhaul link created between them and the small cells 114a, 114b, and 114c can have a backhaul link created within the cluster of small cells 114a, 114b, and 114c. As both the macro cell 112 and the small cells 114a, 114b and 114c have different frequencies f1 and f2, macro cell 112 will not create interference for the small cells 114a, 114b, and 114c, but the small cells 114a, 114b, and 114c can create interference for each another.

FIG. 1C is a schematic network architecture 120 illustrating a scenario of both a macro cell 122 and small cells 124a, 124b, and 124c of different frequencies while at different locations, according to the related art. The macro cell 122 of frequency f1 is outdoors and the cluster of small cells 124a, 124b and 124c of frequency f2 are indoors. The macro cell 122 and the small cells 124a, 124b, and 124c can have a backhaul link created between them and the small cells 124a, 124b, and 124c can have a backhaul link created within the cluster of small cells 124a, 124b, and 124c. Both the macro cell 122 and the small cells 124a, 124b and 124c have different frequencies f1 and f2, but both the indoor and the outdoor cells are different in terms of channel model, and thereby the channel characteristics for the indoor and the outdoor locations vary due to the presence of different channel paths, reflectors, and the like, but are not limited thereto. Due to such factors and parameters, scattering and dispersion can be observed for the small cells 124a, 124b, and 124c, but the small cells 124a, 124b, and 124c can create interference for each another.

FIG. 1D is a schematic network architecture 130 illustrating a scenario of small cells 134a, 134b, and 134c present at an indoor location, according to the related art. The cluster of small cells 134a, 134b and 134c of frequencies f1 or f2 is indoors. The small cells 134a, 134b and 134c can have a backhaul link created between them. As the small cells 134a, 134b and 134c can be of frequencies f1 or f2, while at an indoor location, and due to characteristics such as the presence of different channel paths, reflectors, and the like, scattering and dispersion is observed for the small cells 134a, 134b and 134c, and further, the small cells 134a, 134b and 134c create interference for each another.

Small cells can provide a large portion of data traffic and are also energy efficient due to their lower transmission power. However, a macro cell, for a small portion of data, consumes a large amount of bandwidth and requires higher transmission power due to its larger coverage area for a given bandwidth. Hence it will require a higher power spectral density in a transmission band. Thus, the system becomes power inefficient from a transmission power perspective.

Thus, there is a need for a system and method that adds a small cell after a UE moves to a connected mode on a macro cell via measurement and handover. Further, there is a need for a system and method that triggers handover of a UE to small cells only due to signal strength criterion or due to traffic reasons. Thus, there is need for a system and method for small cell deployment and access in a low power (e.g. “green”) 3GPP LTE System.

### SUMMARY

The present disclosure has been made to address the above-mentioned problems and disadvantages, and to provide at least the advantages described below. Accordingly, an aspect of the present disclosure provides a method and system for providing small cell deployment and access in a green 3GPP LTE system.

The present disclosure provides methods for small cell deployment within a green 3GPP LTE system for efficient data traffic management and reduced power consumption by a User Equipment (UE). The present disclosure provides methods of establishing a connection between the UE and a macro cell within the green 3GPP LTE network, determining one of a small cell in the macro cell for data transfer, verifying a sleep mode of one of the small cells, establishing a connection with the small cell if the small cell is in a wake-up mode, sending a Sounding Reference Signal (SRS) for an initial uplink synchronization, and allocating uplink and downlink resources to the UE, such that the data transfer from the UE is conducted efficiently with reduced power consumption.

### BRIEF DESCRIPTION OF THE DRAWINGS

The above and other aspects, features and advantages of the present disclosure will be more apparent from the following description, taken in conjunction with the accompanying drawings, in which:

FIG. 1A-1D are schematic network diagrams illustrating different scenarios that are observed by UE during connection with macro cell and small cells, according to the related art;

FIG. 2 is a schematic diagram illustrating two types of deployments carried out for a green LTE, wherein the macro cell holds the Radio Resource Control (RRC) with itself and data transfer is performed using small cells, according to an embodiment of the present disclosure;

FIG. 3 is a network architecture illustrating signaling between a macro cell and a small cell, according to an embodiment of the present disclosure;

FIG. 4 is a timing diagram illustrating a method of providing a small cell deployment and access in a green 3GPP LTE system, according to an embodiment of the present disclosure;

FIG. 5 is a schematic network architecture illustrating an UpLink SYNChronization (UL SYNC) mechanism according to an embodiment of the present disclosure;

FIG. 6 is a flow diagram illustrating a message sequence for an uplink/downlink mechanism, according to the present disclosure;

FIGS. 7A and 7B form a flow diagram illustrating a message sequence for an uplink/downlink mechanism, according to the present disclosure;

FIG. 8 is a schematic diagram illustrating two types of deployments carried out for green LTE, wherein both a macro cell and a small cells holds an RRC and data transfer is performed only using the small cells, according to an embodiment of the present disclosure;

FIG. 9 is a network architecture illustrating signaling between a macro cell and a small cell, according to an embodiment of the present disclosure;

FIG. 10 is a timing diagram illustrating a method of providing small cell deployment and access in a green 3GPP LTE system, according to the current embodiment of the present disclosure;

FIG. 11 is a flow diagram illustrating a message sequence for an uplink/downlink mechanism, according to another embodiment of the present disclosure; and

FIG. 12 is a schematic network architecture illustrating a Random Access Channel (RACH) parameter optimization in cells, according to an embodiment of the present disclosure.

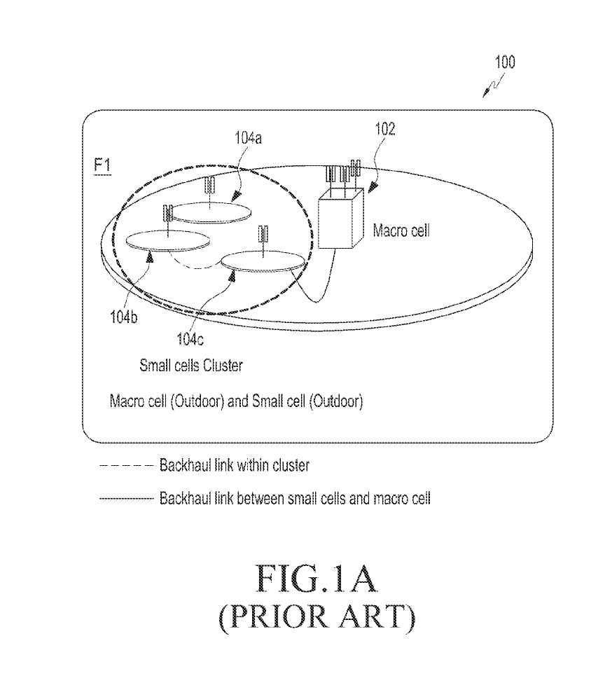

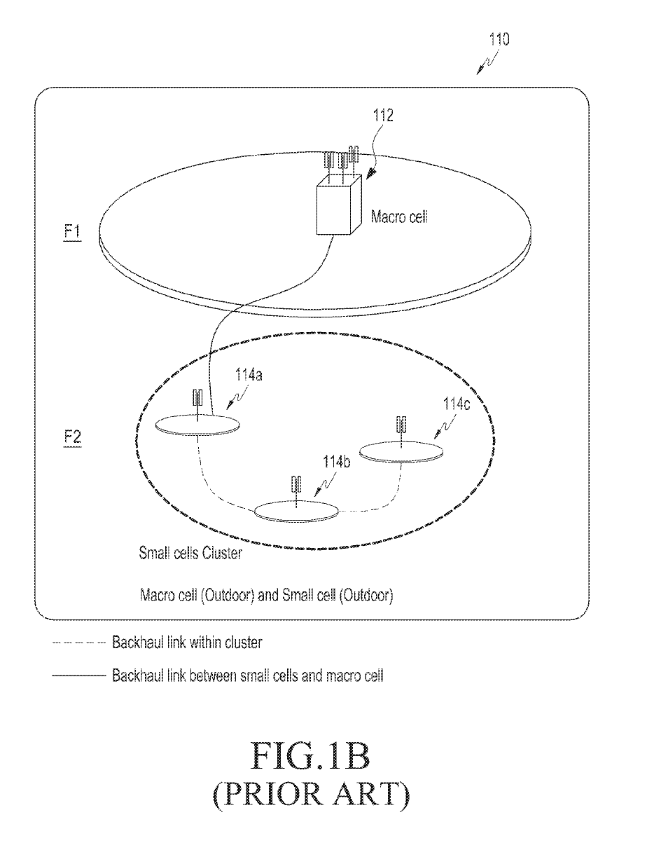

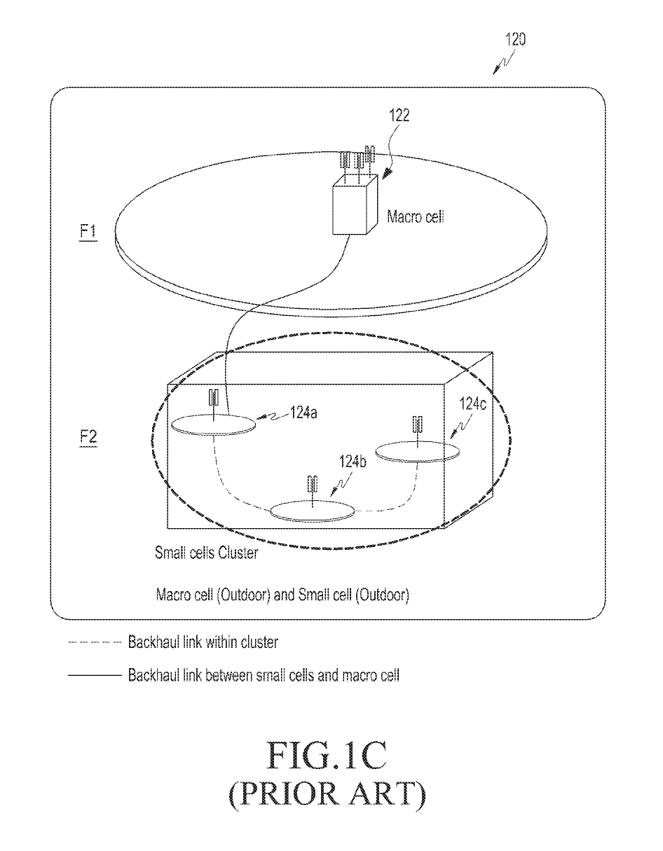

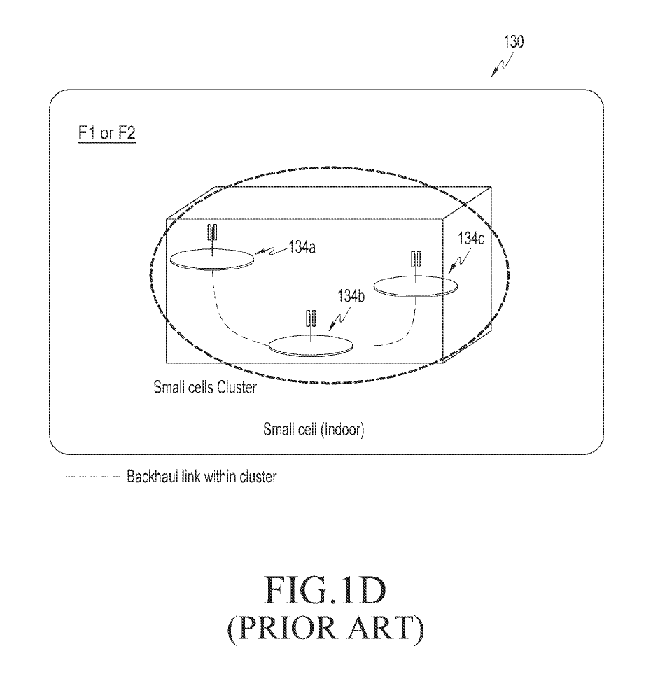

### DETAILED DESCRIPTION OF EMBODIMENTS OF THE PRESENT DISCLOSURE

In the following detailed description of embodiments of the present disclosure, reference is made to the accompanying drawings that form a part hereof, and in which are shown by way of illustration embodiments in which the present disclosure may be practiced. The embodiments of the present disclosure are described in sufficient detail to enable those skilled in the art to practice the present disclosure, and it is to be understood that other embodiments may be utilized and that changes may be made without departing from the scope and spirit of the present disclosure. The following detailed description is, therefore, not to be taken in a limiting sense, and the scope of the present disclosure is defined only by the appended claims and their equivalents.

The specification may refer to “an”, “one” or “some” embodiment(s) of the present disclosure in several locations. This does not necessarily imply that each such reference is to the same embodiment(s), or that the feature only applies to a single embodiment. Single features of different embodiments of the present disclosure may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Described herein are various aspects related to methods for small cell deployment within a green 3GPP LTE system for efficient data traffic management and reduced power consumption by a User Equipment (UE). The present disclosure describes effective methods for establishing a connection between the UE and a macro cell within the green 3GPP LTE network, determining one of a small cell in the macro cell for data transfer, verifying a sleep mode of one of the small cells, establishing a connection with the small cell if the small cell is in a wake-up mode, sending a Sounding Reference Signal (SRS) for an initial uplink synchronization, and allocating uplink and downlink resources to the UE, such that the data transfer from the UE is conducted efficiently with reduced power consumption.

The various embodiments of the present disclosure disclose methods of providing small cell deployment and access in a green 3GPP LTE system, wherein the active mode status of the small cells is checked before allocating the small cell to the UE for data transfer, and thereby reducing power consumption.

According to an embodiment of the present disclosure, a method of providing small cell deployment and access in a green 3GPP LTE system is provided. The method includes establishing, by a User Equipment (UE), a Radio Resource Control (RRC) connection with a macro cell, wherein the RRC connection manages control plane signaling that includes, but is not limited to, connection establishment and release, broadcasting system information, paging notification and release, and configuration of power control and the like. Further, the method comprises receiving an RRC connection establishment message from the UE by the macro cell, wherein the RRC connection establishment message comprises of an Information Element (IE) from the UE to the macro cell along with the identity of a list of small cells within the network of the macro cell on which the UE initiates connection establishment.

Further, the macro cell determines at least one small cell for data transfer. The small cell determined by the macro cell can be any one of the small cells identified by the UE and presented in a list of small cells received by the macro cell. Further, the macro cell verifies whether the at least one small cell is in a sleep mode. The macro cell identifies the at least one small cell which is not in sleep mode (e.g. in wake-up mode) for data transfer. Further, the macro cell triggers a connection setup message for initiating establishment of a connection with the small cell if the at least one small cell is in a wake-up mode. If the small cell is in sleep mode, then the macro cell searches for another small cell from the list received by the UE and verifies whether the cell is in sleep mode or not. The connection set up message is only triggered by the small cell which is in wake-up mode, because the connection between the UE and small cell which is in wake-up (e.g. active) mode is established to use the resources effectively, and thereby avoiding wasting resources as well as time for establishing a connection with small cells.

Further, the UE sends a Sounding Reference Signal (SRS) to the macro cell in an uplink direction. The macro cell can also use the SRS for uplink timing estimation as part of a timing alignment procedure. Further, the at least one small cell allocates an uplink/downlink resource to the UE for communication with the at least one small cell within the macro cell. As the macro cell identifies and verifies the small cell, which is in wake-up mode, before establishing a connection and synchronizing with the UE for data transfer, the time consumed for data transfer is reduced and thereby the power consumption within the macro cell during data transfer is reduced.

Various embodiments of the present disclosure are described for illustrating the various arrangements and set ups in the network architecture to describe the method mentioned above.

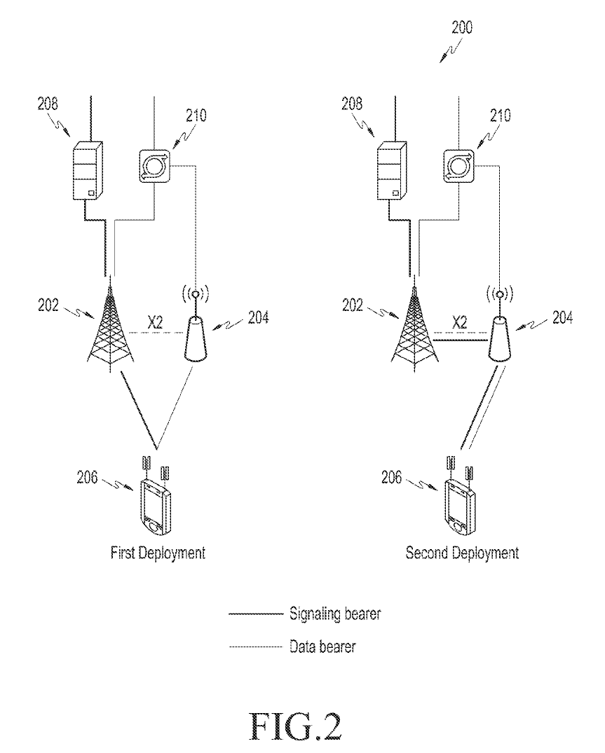

FIGS. 2-7B are schematic diagrams illustrating a method of providing small cell deployment and access in a green 3GPP LTE system, according to an embodiment of the present disclosure. According to the present embodiment, a macro cell controls layer-3 signaling during idle and connected mode and data transfer is carried out using small cells. Therefore, RRC resides with the macro cell and only Packet Data Convergence Protocol/Radio Link Control/Medium Access ControllPhysical Layer (PDCP/RLC/MAC/PHY) resides with the small cells so that the data transfer is performed using the small cells. The following deployment is performed in two ways as described in FIG. 2.

FIG. 2 is a schematic diagram illustrating two types of deployments 200 carried out for green LTE, wherein the macro cell 202 still holds the RRC with itself and data transfer is performed using the small cell 204, according to an embodiment of the present disclosure.

Referring to FIG. 2, the deployments 200 include the macro cell 202, a small cell 204, a UE 206, a Mobility Management Entity (MME) 208, and a Serving GateWay (S-GW) 210. The MME 208 is responsible for tracking and paging procedures including retransmissions along with an idle mode of the UE 206. The S-GW 210 is responsible for handovers with neighboring macro cells and data transfer in terms of all packets of the UE 206. The embodiment of the present disclosure is done in two types of deployments 200 wherein the macro cell 202 controls Layer-3 (L3) signaling or controls the RRC to reside with the macro cell 202 and, only for data transfer or PDCP/RLC/MAC/PHY, reside with the small cell 202, and the two types of deployments 200 are done as described below.

In the first deployment, the UE 206 maintains the RRC signaling bearer with the macro cell 202. Therefore, whenever there is a requirement to send Layer-3 (L3) level processing signaling data for mobility and bearer establishment, security, session setup and management related procedures, the UE 206 sends such signals directly to the macro cell 202. The UE 206 directly sends and receives a signal bearer with the macro cell 206. Further in the first deployment, whenever the UE 206 must establish a bearer for data traffic, the UE 206 establishes a connection with the macro cell 202, notifies the macro cell 202 regarding its requirement of the bearer for the data transfer, and, based on the requirement of the UE 206, the macro cell 202 exchanges Access Stratum (AS) configuration parameters with a designated small cell 204 for a radio bearer to be setup for data traffic via the small cell 204.

Whenever there is simultaneous traffic on a signal bearer and a data bearer, the scenario will be treated like a carrier aggregation scenario but signaling traffic will be sent on the macro cell carrier, and data traffic will be sent on the small cell carrier. It is assumed that a signal bearer is active during the life-span of the data bearer. According to the first deployment, whenever the UE 206 wants to transfer data, the UE 206 sends a signal bearer to the macro cell 202. Upon receiving the signal bearer from the UE 206, the macro cell 202 sends the AS configuration parameters to the selected small cell 204 indicating to the small cell 204 that the UE 206 is in need of a carrier for data transfer. Once the small cell 204 receives the AS configuration parameters, the small cell 204 allocates small cell carriers to the UE 206 for data transfer, wherein the UE 206 uses the small cell carriers of the small cell 204 to transfer data to the S-GW 210.

In the second deployment, L3 level processing signaling data resides with the macro cell 202. In the second deployment, whenever the UE 206 must establish a bearer for data traffic, the UE 206 establishes a connection with the macro cell 202, and the macro cell 202 exchanges the AS configuration parameters with designated the small cell 204 for a radio bearer to be setup for data traffic via the small cell 204. Then, the signaling bearer with the macro cell 202 is merged with the small cell 204; thereby all traffic including the signal bearer along with the data bearer is sent to the small cell 204. Processing of the RLC and the PDCP is done at the small cell 204 and L3 level processing of signaling data is relayed to the macro cell 202 for mobility and bearer establishment, security, session setup and management related procedures. As the signal bearing and data bearing are done via the small cell 204, the second deployment requires a robust backhaul link between the macro cell 202 and the small cell 204.

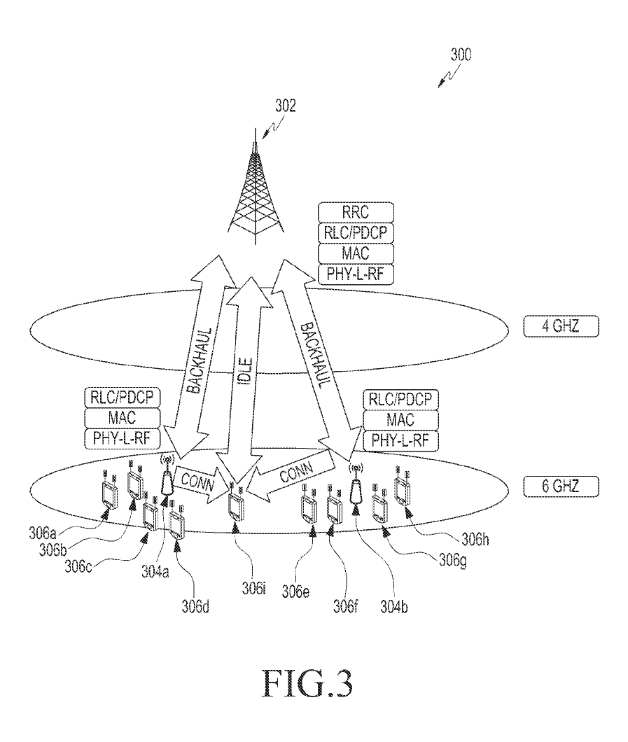

FIG. 3 is a network architecture 300 illustrating signaling between a macro cell 302 and a first small cell 304a and a second small cell 304b, according to an embodiment of the present disclosure.

Referring to FIG. 3, and according to the second deployment described above, the RRC connection resides with the macro cell 302 and RLC/PDCP/MAC/PHY-H-RF resides with the small cells 304a or 304b. The network architecture 300 includes a macro cell 302 that includes RRC, RLC, PDCP, MAC, and PHY-L-RF connections, the first small cell 304a and the second small cell 304b that include RLC, PDCP, MAC, and PHY-H-RF connections, and a plurality of UE 306a, 306b, 306c, and 306d that are connected to the first small cell 304a, and the plurality of UEs 306e, 306f, 306g, and 306h that are connected to the second small cell 304b. The macro cell 302 communicates with the first small cell 304a, the second small cell 304b, and the UEs 306a, 306b, 306c, 306d, 306e, 306f, 306g, and 306h over a 4 GHz bandwidth channel or carrier, and the first small cell 304a and the second small cell 304b communicates with the UEs 306a, 306b, 306c, 306d, 306e, 306f, 306g, and 306h over a 6 GHz bandwidth channel or carrier. The network 300 includes another UE 306i, wherein the UE 306i is initially connected via an idle mode connection with the macro cell 302. The first small cell 304a and the second small cell 304b has a backhaul connection with the macro cell 302.

According to the network architecture described above and its two possible deployments, the UE 306i can encounter two cases, wherein the first small cell 304a and the second small cell 304b can be in a sleep state or in a wake-pp state. In this case, the small cell in the sleep state can only transmit discovery signals as defined in 3GPP LTE Release 12/13. A small cell cannot listen to any Random Access Channel (RACH) attempts while in a sleep state. If the UE 306i is measuring the first small cell 304a and the second small cell 304b, then as per the current 3GPP LTE Release 12/13 design, the UE 306i can easily identify if a small cell is in a sleep state or not by virtue of a Discovery Reference Signal (DRS) or Channel Reference Signal/Channel State Information Reference Signal (CRS/CSI-RS) measurements. The deployments described above can be applied to the network architecture, and therefore is not described herein to avoid repetition.

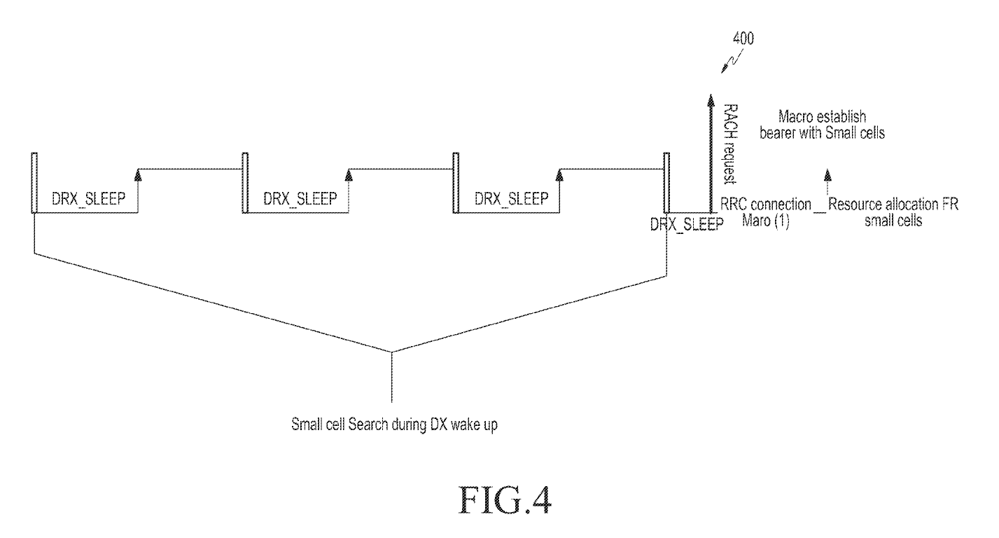

FIG. 4 is a timing diagram 400 illustrating a method of providing small cell deployment and access in a green 3GPP LTE system, according to an embodiment of the present disclosure.

Referring to FIG. 4, the timing diagram 400 describes a number of searches for small cells at pre-determined time intervals of the small cells. A UE sends a RACH access message with a cell list as identified by the UE and then in an RRC connection setup message the network informs the UE about the selected small cell. Upon establishing the RRC connection, a macro cell establishes a bearer with the small cells and allocates resources to the small cells so that the small cells can facilitate data transfer to the UE that requested the data transfer from the small cells.

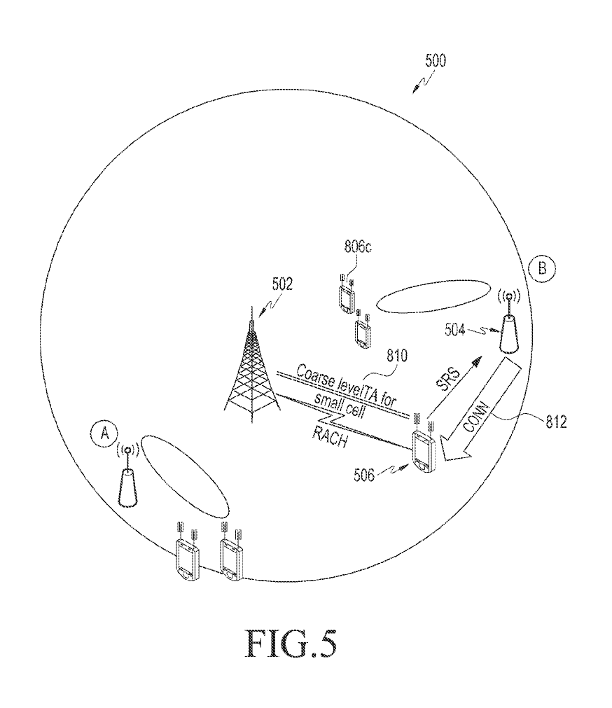

FIG. 5 is a schematic network architecture 500 illustrating an UpLink SYNChronization (UL SYNC) mechanism for the deployments as described in an embodiment of the present disclosure.

Referring to FIG. 5, the network architecture 500 includes a macro cell 502, a UE 506, and a small cell 504. The macro cell 502 can further include one or more small cells within its coverage area, and the small cells can include a plurality of UEs associated with them for data transfer. The network architecture 500 illustrates the flow of signals between the macro cell 502, the UE 506, and the small cell 504. The network architecture 500 and the communication between the macro cell 502, the UE 506 and the small cell 504 with respect to the two deployments described above is described below.

First, the UE 506 establishes an RRC connection with the macro cell 502 during a connection establishment procedure. Upon establishment of the connection, the macro cell 502 provides a Timing Advance (TA) in a Random Access Response (RAR) with respect to the macro cell 502. Further, the macro cell 502 provides a coarse level TA for the selected small cell 504 by the UE 506 in a TA Medium Access Control (MAC) Protocol Data Unit (PDU). Thus, the UE 506 can get a coarse level timing advance from the small cell 504 for the first transmission.

If the small cell 504 identifies that the coarse level TA for the UE 506 is within the limits of correctness, then the small cell 504 sends a TA MAC PDU to the UE 506 in response to the SRS sent by the UE 506 in order to conduct a fine adjustment of the TA PDU and an UpLink (UL)/DownLink (DL) resource allocation and communication. If the small cell 504 identifies that the coarse level TA for the UE 506 is out of the limits of correctness, then the small cell 504 sends a default TA to the UE 506 and the UE 506 initiates the RACH to continue the course of operation.

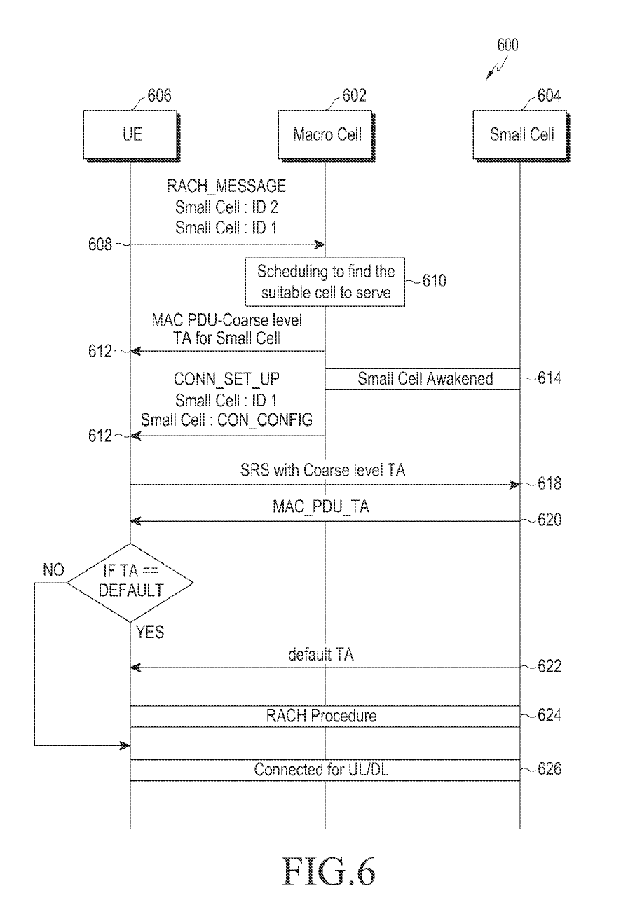

FIG. 6 is a flow diagram 600 illustrating a message sequence for an uplink/downlink mechanism for the first deployment of an embodiment of the present disclosure.

Referring to FIG. 6, a UE 606 sends a RACH message to a macro cell 602 in step 608, wherein the RACH message includes information about the small cells with identifiers ID1 and ID2 present within the network area of the macro cell 602 to which the UE 606 wishes to associate for data transfer. Upon receiving the RACH message from the UE 606, the macro cell 602 schedules the small cells to identify a suitable small cell for the UE 606 to associate with for data transfer in step 610.

The macro cell 602 identifies the small cell ID1 604 as the suitable small cell for the UE 606 for data transfer, and sends a MAC PDU-coarse level TA for the small cell 604 in step 612 and, at the same time, the small cell ID1 604 is awakened in step 614. Then, the macro cell 602 sends a connection setup CONN_SET_UP message to the UE 602 in step 616, wherein the configuration set up message includes the small cell's 604 information such as the name of the small cell 604, configuration details, and the like. Upon receiving the configuration set up message, the UE 606 sends an SRS with course level TA message to the small cell 604 to measure the TA in step 618, and then the small cell 604 can sends a MAC PDU TA to the UE 606 in step 620, If the TA is default TA, the small cell 604 sends the default TA to the UE 606 in step 622, upon which the UE 606 sends the RACH message again for a new small cell in step 624. If the TA is not default TA, the UE 606 makes a connection with the small cell 604 for UpLink (UL)/DownLink (DL) in step 626.

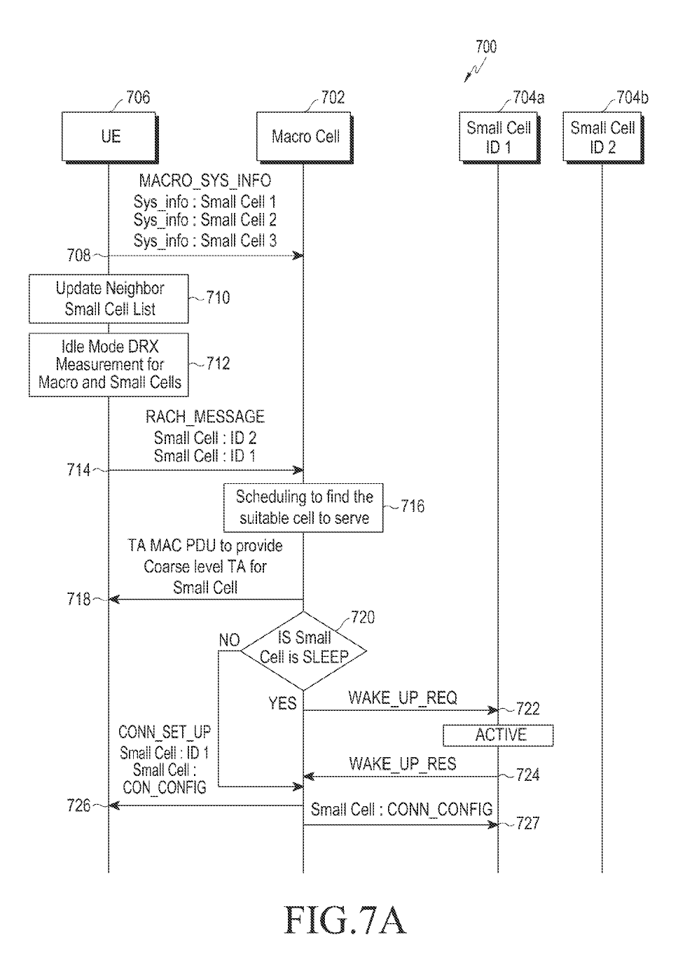

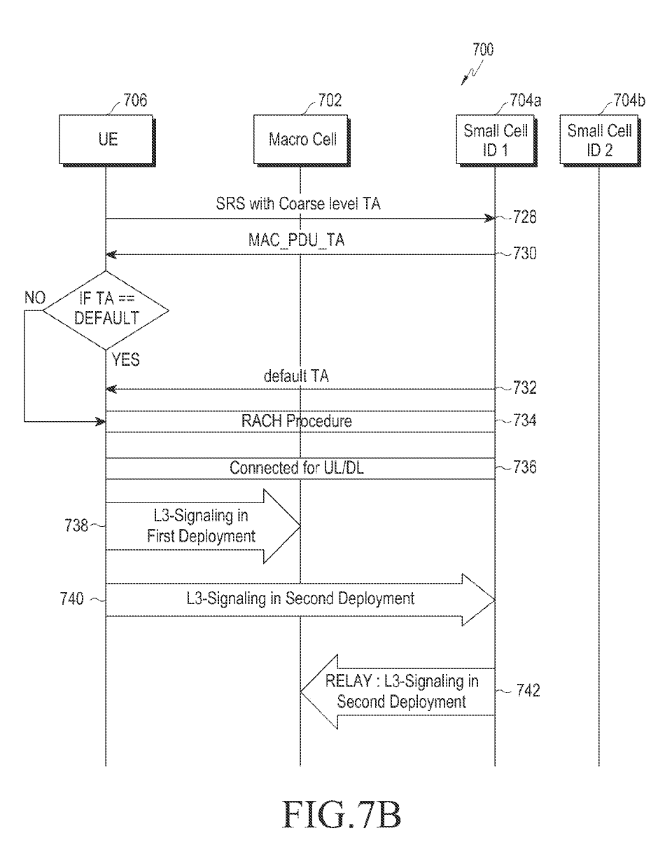

FIGS. 7A and 7B form a flow diagram 700 illustrating a message sequence for an uplink/downlink mechanism for the second deployment of an embodiment of the present disclosure.

Referring to FIGS. 7A and 7B, a UE 706 receives macro system information (e.g. MACRO_SYS_INFO) from a macro cell 702 in step 708, wherein the macro system information includes small cells available within the network area of the macro cell 702. Upon receiving the macro system information, the UE 706 updates a neighbor small cell list in step 710. The UE 706 conducts idle mode Discontinuous Reception by UE (DRX) measurements for the macro cell 702 and the small cells present within the macro cell 702 in step 712. The UE 706 sends a RACH message to the macro cell 702 in step 714, wherein the RACH message includes information about the selected small cells with identifiers ID and ID2 present within the network area of the macro cell 702 to which the UE 706 wishes to associate with for data transfer. Upon receiving the RACH message from the UE 706, the macro cell 702 schedules the small cells to identify the suitable small cell for the UE 706 to associate with for data transfer in step 716.

The macro cell 702 identifies the first small cell ID 1 704a as the suitable small cell for the UE 706 for data transfer, and sends a MAC PDU-coarse level TA for the first small cell ID1 704a to the UE 706 in step 718. The macro cell 702 checks whether the first small cell ID1 704a is in the sleep state in step 720. If the first small cell ID1 704a is in the sleep state, then the macro cell 702 sends a wake up request message (e.g. WAKE_UP_REQ) to the first small cell ID1 704a in step 722. If the first small cell ID1 704a is in the sleep state, can receive the message and switch to active (e.g. awake) mode, the first small cell ID1 704a sends a wake up response message (e.g. WAKE_UP_RES) to the macro cell 702 in step 724. If the macro cell 702 identifies that the first small cell ID1 704a is not in the sleep state in step 720, then the macro cell 702 identifies that the first small cell ID1 704a is active and ready for communication with the UE 706.

Upon identifying that the first small cell ID 704a is in the active mode, the macro cell 702 sends a connection set up message (e.g. CONN_SET_UP) to the UE 706 in step 726, wherein the configuration set up message includes first small cell ID1 704a information such as the name of the first small cell ID1 704a, configuration details, and the like. Further, the macro cell 702 sends “connection configuration message (CONN_CONFIG) to the small cell ID 1. Upon receiving the configuration set up message, the UE 706 sends an SRS with coarse level TA message to the first small cell ID1 704a in step 728. If the first small cell ID1 704a identifies that the coarse level TA is well within the correction level, then the small cell ID1 704a sends a MAC PDU TA message to the UE 706 in step 730, and If TA is default TA, the first small cell ID1 704a sends a default TA message to the UE 706 in step 732, upon which the UE 706 sends the RACH message again for new small cell in step 734. If TA is not default TA, the UE 706 makes a connection with the first small cell ID1 704a for uplink (UL)/downlink (DL) in step 736. Upon establishing UL/DL, all L3 signaling is relayed to the macro cell 702 in steps 738, 740a, and 740b, in order to make a decision for all L3 control signaling.

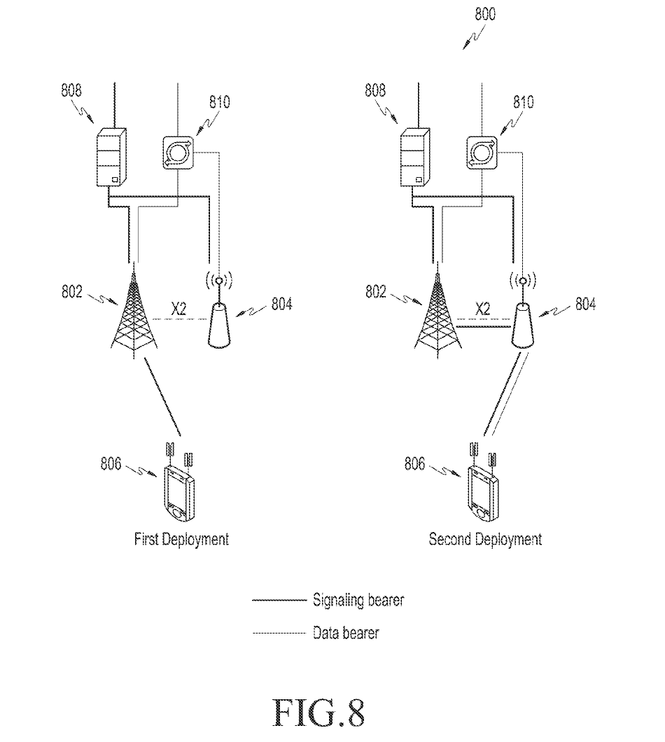

FIGS. 8-11 are schematic diagrams illustrating a method of providing small cell deployment and access in a green 3GPP LTE system, according to an embodiment of the present disclosure. According to an embodiment of the present disclosure, a Radio Resource Control (RRC) at a macro cell can only process an idle mode scenario and, at the same time, an RRC can be at small cells to process L3 signaling during a connected mode. Accordingly, mobility scenarios can be processed by the macro cells during an idle mode and processed by the small cells during a connected mode. The following deployment can be performed in two ways as described in FIG. 8.

Referring to FIG. 8, a schematic diagram 800 illustrates two types of deployments carried out for green LTE, wherein both macro cell and small cell holds the RRC and data can be transferred using only the small cells, according to an embodiment of the present disclosure. The deployments include a macro cell 802, a small cell 804, a UE 806, a Mobility Management Entity (MME) 808, and a Serving GateWay (S-GW) 810. The MME 808 is responsible for a tracking and paging procedure, retransmissions, and an idle mode of the UE 806. The S-GW 810 is responsible for handovers with neighboring macro cells and data transfer for all packets of the UE 806. An embodiment of the present disclosure can be done in two types of deployments, wherein the macro cell 802 or small cell 804 can maintain a signaling connection with an Evolved Packet Core (EPC) during mobility, and the small cells 804 can maintain a data signal with the S-GW 810 during a connected mode and a signaling connection with the MME 808 to handle mobility scenario, where the two types of deployments are described below.

In the first deployment, the UE 806 maintains the RRC signal bearer with the macro cell 802 in order to send L3 level processing signaling data to the macro cell 802 when there is no data traffic. In the second deployment, the UE 206 connects to the small cell 804 for the data traffic, and when the data bearer is available from the small cell 804, L3 control signaling can be transmitted via the small cell 804 to the macro cell 802. As described above, the small cells 804 can have a backhaul connection with the macro cell 802 to process handover conditions.

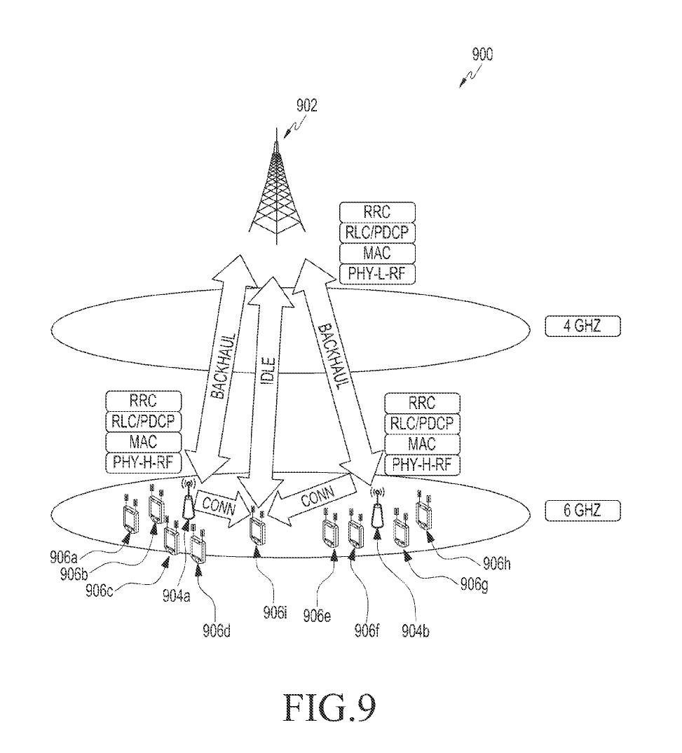

FIG. 9 is a network architecture 900 illustrating signaling between a macro cell 902 and a first small cell 904a and a second small cell 904b, according to an embodiment of the present disclosure.

Referring to FIG. 9, and according to the second deployment described above, the RRC connection and RLC/PDCP/MAC/PHY-H-RF can reside with both the macro cell 902 and the first small cell 904a and the second small cell 904b. The network architecture 900 includes the macro cell 902 that includes RRC, RLC, PDCP, MAC, and PHY-L-RF connections, first small cell 904a, and second small cell 904b that include RRC, RLC, PDCP, MAC, and PHY-L-RF connections, and a plurality of UEs 906a, 906b, 906c, and 906d that are connected to the first small cell 904a, and a plurality of UEs 906e, 906f, 906g, and 906h that are connected to the second small cell 904b. The macro cell 902 communicates with the first small cell 904a, the second small cell 904b, and the UEs 906a, 906b, 906c, 906d, 906e, 906f, 906g, and 906h over a 4 GHz bandwidth channel or carrier, and the first small cell 904a and the second small cell 904b communicates with the UEs 906a, 906b, 906c, 906d, 906e, 906f, 906g, and 906h over a 6 GHz bandwidth channel or carrier. The network 900 includes another UE 906i, wherein the UE 906i initially has an idle mode connection with the macro cell 902. The first small cell 904a and the second small cell 904b can have a backhaul connection with the macro cell 902.

According to the network architecture and its two possible deployments described above, the UE 906i can encounter two cases, wherein the first small cell 904a and the second small cell 904b can be in a sleep state or in a wake-up state. In the sleep state, the sleeping cell can only transmit discovery signals as defined in 3GPP LTE Release 12/13. A small cell cannot listen to any RACH attempts during a sleep state. The UE 906i can connect to the macro cell 902 only for L3 control signaling when the UE 906 does not wish to transfer data. If the UE 906 wishes to transfer data using the first small cell 904a or the second small cell 904b, then, as per the current 3GPP LTE-Release 12/13 design, the UE 906i can connect to the first small cell 904a or the second small cell 904b for data traffic and when the bearer is available, then the L3 control signaling is transmitted via the first small cell 904a or the second small cell 904b to the macro cell 902. The rest of the process for processing data is performed as described in the aforementioned embodiment of the present disclosure.

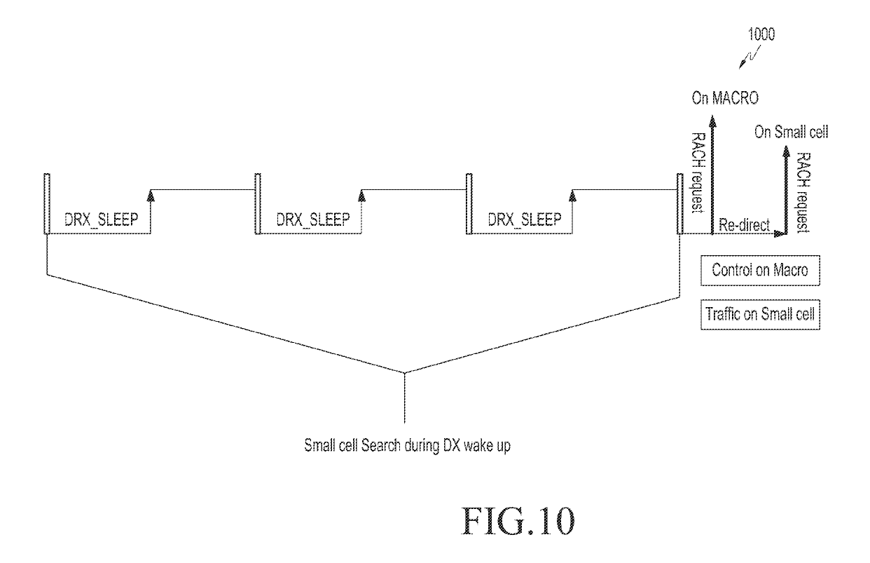

FIG. 10 is a timing diagram 1000 illustrating a method of providing small cell deployment and access in a green 3GPP LTE system, according to an embodiment of the present disclosure.

Referring to FIG. 10, the timing diagram 1000 describes a number of attempts carried out for searching for small cells at pre-determined time intervals of the small cells. The UE establishes an RRC connection with a macro cell. The macro-cell-based scheduling decision then finds the suitable cell and releases the RRC connection with the UE. In the release message, the macro cell will re-direct the UE to the selected small cell. The UE will establish another RRC connection with the small cell. The difference from FIG. 4 is this design does not require a large amount of traffic on a backhaul between the macro and the small cell.

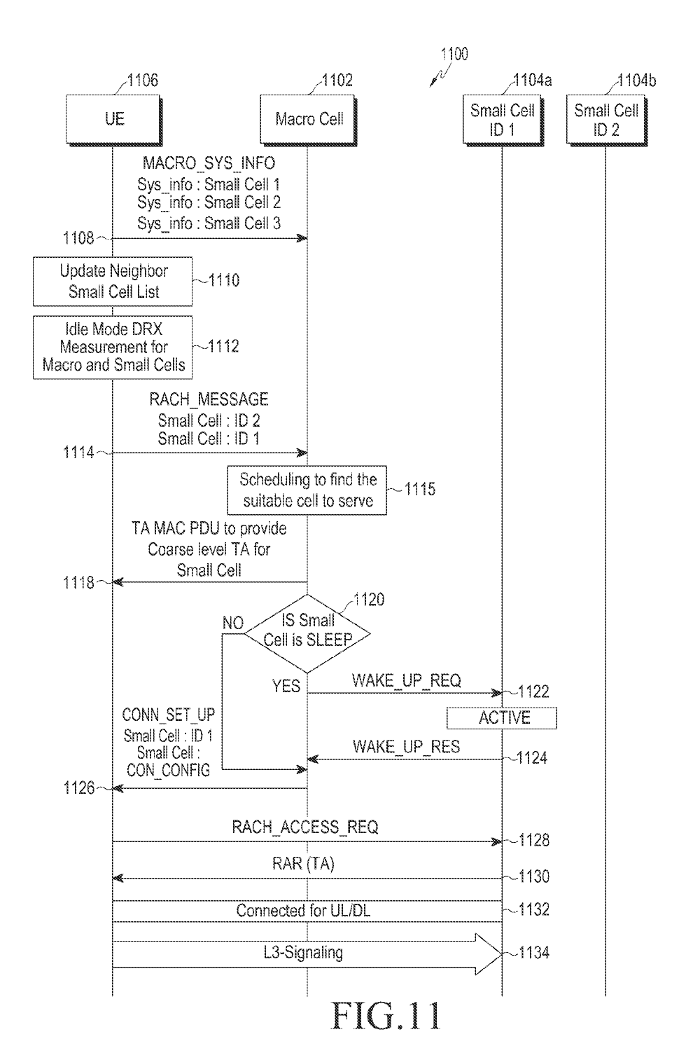

FIG. 11 is a flow diagram 1100 illustrating a message sequence for an uplink/downlink mechanism, according to an embodiment of the present disclosure.

Referring to FIG. 11, the UE 1106 receives macro system information (e.g. MACRO_SYS_INFO) from a macro cell 1102 in step 1108, wherein the macro system information includes the small cells available within the network area of the macro cell 1102.

Upon receiving the macro system information, the UE 1106 updates the neighbor small cell list in step 1110. The UE 1106 conducts idle mode DRX measurements for the macro cell 1102 and the small cells present within the macro cell 1102 in step 1112. The UE 1106 sends a RACH message to the macro cell 1102 in step 1114, wherein the RACH message includes information about the selected small cells with identifiers ID1 and ID2 present within the network area of the macro cell 1102 to which the UE 1106 wishes to associate with for data transfer. Upon receiving the RACH message from the UE 1106, the macro cell 1102 schedules the small cells to identify the suitable small cell for the UE 1106 to associate with for transferring data in step 1115.

The macro cell 1102 identifies the first small cell ID1 1104a as the suitable small cell for the UE 1106 for data transfer and sends a MAC PDU-coarse level TA for the first small cell ID1 1104a in step 1118. The macro cell 1102 checks whether the first small cell ID1 1104a is in a sleep state in step 1120. If the first small cell ID1 1104a is in the sleep state, then the macro cell 1102 sends a wake up request message (e.g. WAKE_UP_REQ) to the first small cell ID1 1104 in step 1122. If the first small cell ID1 1104a is in the sleep state, the first small cell ID1 1104a receives the message, switches to an active (e.g. awake) mode, and sends a wake up response message (e.g. WAKE_UP_RES) to the macro cell 1102 in step 1124. If the macro cell 1102 identifies that the first small cell ID1 1104a is not in the sleep state, then the macro cell 1102 identifies that the first small cell ID1 1104a is in the active mode and ready for communication with the UE 1106.

Upon identifying that the first small cell ID 1104a is in the active mode, the macro cell 1102 sends a connection set up message (e.g. CONN_SET_UP) to the UE 1102 in step 1126, wherein the configuration set up message includes small cell information such as a name of the small cell, configuration details, and the like. Upon receiving the configuration set up message, the UE 1106 sends a RACH access request message (e.g. RACH_ACCESS_REQ) to the first small cell ID1 1104a in step 1128. Upon receiving the RACH access request message, the first small cell ID1 1104a sends RACH access response message to the UE 1106 in step 1130, and the UE 1106 makes a connection with the first small cell ID1 1104a for UpLink (UL)/DownLink (DL) in step 1132. Upon establishing UL/DL, all L3 signaling is relayed to the first small cell ID1 1104a in step 1134, in order to make decisions for all L3 control signaling.

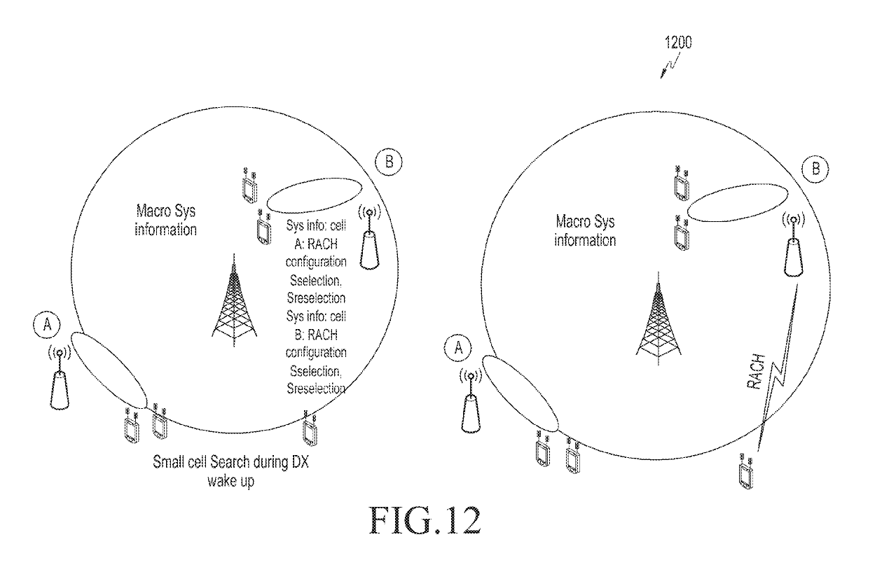

In the above mentioned embodiments of the present disclosure, the macro cell sends small cell selection and acquisition information in system information. In addition to Selection criteria (S-criteria), cell identifiers, frequency and other related information, the macro cell can also send the RACH configuration information for all the small cells in the macro cell system information. This can enable the UE to start measurements on the small cells, and can apply initial access on the small cells as per the procedure described above for all neighbor small cells and the macro cell. The procedure of sending system information is illustrated in FIG. 12.

As soon as the UE triggers a connection request, either due to a Mobile Originated (MO) call, or paging for the Mobile Terminal (MT) call, the UE can trigger search on the given neighbor cell set in addition to optimizations to search small cells and the macro cell found during DRX measurement. The UE can make a list of the macro cells and the small cells as per their received signal strength on reference symbols. As per the current 3GPP design, the UE may need to achieve the acquisition on the best small cell as per the selection criterion, and then find the RACH information on the target small cell before triggering the random accesses request. However, the delay of reading system information can be minimized by sending primary small cell related information as an addition to macro cell System Information Block (SIB) information. This will help in achieving the acquisition without reading system information at the small cell. The UE will select the best cell and will make a RACH attempt to achieve initial RRC connection. It is possible to optimize the random access related parameters to reduce the load of the macro cell by means of transmitting common RACH information and specific RACH information separately, or implicit derivation of parameters from the macro cell's parameter using offset or delta information transmission.

Further, the additional points which are to be considered for RACH parameter optimization comprises:
a. categorizing RACH parameters as common information applicable to all small cells, and transmitting once per transmission period.
b. RACH parameters which are not common, must be shared per cell basis, and will be indicated along with the cell identifier of the small cell.

In the embodiments of the present disclosure, measurement of small cells also plays an important role, as the information about the small cells present within the macro cell can be helpful for making the list and scheduling of the small cells before transferring data. When the UE decides to measure small cells, some small cells could be in the sleep state and some small cells could be in the awake state (e.g. wake up mode). Thus, for the UE to indicate the possible small cells to the macro cell during random access, it may need to apply some criteria when it ranks small cells based on DRS and CSI-RS measurement as both have different measurement quantities as follows:

i. Discovery Reference Signal (RS) is different from Channel State Information-Reference Signal (CSI-RS) (Primary Synchronization Signal/Secondary Synchronization Signal (PSS/SSS)) signals. A new measurement quantity can be defined called Discovery Reference Signal Received Power (RSRP), and used to maintain the best small cell in the sleep state.

ii. If the small cell is in the awake state, then the small cells can transmit CSI-RS like a normal cell, and the UE will maintain this small cell in the awake state, where the small cell identifiers must be indicated via the macro cell SIB, so that the UE can identify if the measure cell is a macro cell or a small cell.

The list arrived at during the RRC Idle State is described in Table 1 below.

TABLE 1

| | | | Small cell |
|---|---|---|---|
| Rank | Macro Cell | Small cell (Active) | (Dormant/Sleeping) |
| 1 | Serving cell | Active small cell 1 | Dormant small cell 1 |
| 2 | Neighbor cell 1 | Active small cell 2 | Dormant small cell 2 |
| 3 | Neighbor cell 2 | . . . | . . . |
| . . . | . . . | . . . | . . . |
| N | Neighbor cell N | Active small cell N | Dormant small cell N |

Between small cell lists (Active vs. Sleeping), ranking can be merged like in Table 2 below based on a translation of Discovery RSRP to a normal RSRP, so that the UE can choose the small cell on which to attempt access when the need arises. The translation could be an absolute offset, a multiplication factor, or a combination of both which can be applied to Discovery RSRP to make it a normal RSRP.

TABLE 2

| Rank | Merged Small Cell Ranking |
|---|---|
| 1 | Dormant Small cell 1 |
| 2 | Active Small cell 1 |
| 3 | Active Small cell 2 |
| 4 | Dormant Small cell 2 |
| . . . | . . . |
| . . . | . . . |

The present disclosure has been described with reference to embodiments thereof, it will be evident that various modifications and changes may be made to these embodiments without departing from the scope and spirit of the present disclosure. Furthermore, the various devices, modules, and the like described herein may be enabled and operated using hardware circuitry, for example, Complementary Metal Oxide Semiconductor (CMOS) based logic circuitry, firmware, software and/or any combination of hardware, firmware, and/or software embodied in a machine readable medium.

Although the present disclosure is with various certain embodiments, it will be obvious for a person skilled in the art to practice the disclosure with modifications. However, all such modifications are deemed to be within the scope and spirit of the present disclosure, as defined by the appended claims and their equivalents.

What is claimed is:

1. A method of providing small cell deployment and access in a green 3^{rd} Generation Partnership Project (3GPP) Long Term Evolution (LTE) system, the method comprising:
establishing, by a User Equipment (UE), a Radio Resource Control (RRC) connection with a macro cell;
receiving, by the macro cell, an RRC connection establishment message from the UE, wherein the RRC connection establishment message comprises an Information Element (IE) including an identity of a list of small cells on which the UE can initiate a connection;
determining, by the macro cell, at least one small cell for data transfer;
verifying, by the macro cell, if the at least one small cell is in a sleep mode or not;
triggering, by the macro cell, a connection setup message for initiating a connection between the UE and the at least one small cell if the at least one small cell is in a wake up mode;
sending, by the UE, a Sounding Reference Signal (SRS) for initial timing alignment; and
allocating, by the at least one small cell, an uplink/downlink resource to the UE for communication with the at least one small cell.

2. The method of claim 1, wherein allocating the uplink/downlink resources to the UE comprises:
sending, by the UE, the SRS for initial time alignment according to connection configuration information received from the macro cell; and
providing, by the macro cell, coarse level Timing Advance (TA) information in a Medium Access Control (MAC) Protocol Data Unit (PDU) for the selected small cell to the UE to adjust the timing;
checking, by the UE, if the coarse level TA information is within an acceptable level of correctness or not; and
sending, by the at least one small cell, TA information in the MAC PDU to the UE in response to the SRS if the coarse level TA is within the acceptable level of correctness.

3. The method of claim 1, further comprising:
sending, by the macro cell, a wake up request signal to the at least one small cell if the at least one small cell is in the sleep mode; and
receiving a wake up response signal from the at least one small cell when the at least one small cell is active.

4. The method of claim 1, wherein the UE maintains the connection with the macro cell for Layer 3 (L3) control signaling when there is no data traffic.

5. A User Equipment (UE), comprising:
a transmitter configured to send a Random Access Channel (RACH) message to a macro cell;
a receiver configured to receive, from the macro cell, a Medium Access Control (MAC) Protocol Data Unit (PDU) coarse level Timing Advance (TA) for a small cell suitable for data transfer with the UE, and receive, from the macro cell, a connection setup message,
wherein the transmitter is further configured to send a Sounding Reference Signal (SRS) with a course level TA message to the small cell to measure the TA, and
wherein the receiver is further configured to receive, from the small cell, a MAC PDU TA; and
a controller configured to establish a connection with the small cell for UpLink/Downlink (UL/DL).

6. The UE of claim 5, wherein the RACH message includes information about small cells with identifiers ID1 and ID2 present within a network area of the macro cell to which the UE wishes to associate for data transfer.

7. The UE of claim 5, wherein the RACH message is used to identify a suitable small cell for the UE to associate with for data transfer.

8. The UE of claim 5, wherein the connection set up message includes information of the small cell that includes a name of the small cell and configuration details of the small cell.

9. A method of establishing a connection by a User Equipment (UE), comprising:
sending a Random Access Channel (RACH) message to a macro cell;
receiving, from the macro cell, a Medium Access Control (MAC) Protocol Data Unit (PDU) coarse level Timing Advance (TA) for a small cell suitable for data transfer with the UE;
receiving, from the macro cell, a connection setup message;
sending a Sounding Reference Signal (SRS) with a course level TA message to the small cell to measure the TA;
receiving, from the small cell, a MAC PDU TA; and
establishing a connection with the small cell for UpLink/Downlink (UL/DL).

10. The method of claim 9, wherein the RACH message includes information about small cells with identifiers ID1 and ID2 present within a network area of the macro cell to which the UE wishes to associate for data transfer.

11. The method of claim 9, wherein the RACH message is used to identify a suitable small cell for the UE to associate with for data transfer.

12. The method of claim 9, wherein the connection set up message includes information of the small cell that includes a name of the small cell and configuration details of the small cell.

13. A chip set, configured to:
send a Random Access Channel (RACH) message to a macro cell;
receive, from the macro cell, a Medium Access Control (MAC) Protocol Data Unit (PDU) coarse level Timing Advance (TA) for a small cell suitable for data transfer with the UE;
receive, from the macro cell, a connection setup message;
send a Sounding Reference Signal (SRS) with a course level TA message to the small cell to measure the TA;
receive, from the small cell, a MAC PDU TA; and
establish a connection with the small cell for UpLink/Downlink (UL/DL).

14. The chip set of claim 13, wherein the RACH message includes information about small cells with identifiers ID1 and ID2 present within a network area of the macro cell to which the UE wishes to associate for data transfer.

15. The chip set of claim 13, wherein the RACH message is used to identify a suitable small cell for the UE to associate with for data transfer.

16. The chip set of claim 13, wherein the connection set up message includes information of the small cell that includes a name of the small cell and configuration details of the small cell.

17. A method of establishing a connection by a communication chip, comprising:
sending a Random Access Channel (RACH) message to a macro cell;
receiving, from the macro cell, a Medium Access Control (MAC) Protocol Data Unit (PDU) coarse level Timing Advance (TA) for a small cell suitable for data transfer with the UE;
receiving, from the macro cell, a connection setup message;
sending a Sounding Reference Signal (SRS) with a course level TA message to the small cell to measure the TA;
receiving, from the small cell, a MAC PDU TA; and
establishing a connection with the small cell for UpLink/Downlink (UL/DL).

18. The method of claim 17, wherein the RACH message includes information about small cells with identifiers ID1 and ID2 present within a network area of the macro cell to which the UE wishes to associate for data transfer.

19. The method of claim 17, wherein the RACH message is used to identify a suitable small cell for the UE to associate with for data transfer.

20. The method of claim 17, wherein the connection set up message includes information of the small cell that includes a name of the small cell and configuration details of the small cell.
